(19) United States
(12) Patent Application Publication
(10) Pub. No.: US 2015/0014482 A1
(43) Pub. Date: Jan. 15, 2015

(54) UNMANNED AERIAL VEHICLE (UAV) WITH INTER-CONNECTING WING SECTIONS

(71) Applicant: Design Intelligence Incorporated, LLC, Norman, OK (US)

(72) Inventors: Jacob R. Weierman, Stillwater, OK (US); James L. Grimsley, Noble, OK (US)

(21) Appl. No.: 14/330,586

(22) Filed: Jul. 14, 2014

Related U.S. Application Data
(60) Provisional application No. 61/846,508, filed on Jul. 15, 2013.

(51) Int. Cl. B64C 3/54; H01L 31/042; B64D 43/00

(52) U.S. Cl. CPC B64C 3/54; B64D 43/00; H01L 31/0422
USPC 244/124

(57) ABSTRACT

An unmanned aerial vehicle (UAV) is described. The UAV may include a fuselage assembly and a plurality of inter-connecting wing sections. The inter-connecting wing section may include a connecting assembly on opposing lateral ends. The connecting assembly may be complementary on opposing ends. The fuselage assembly may include a complementary set of the connecting assembly on opposing lateral ends. The complementary set of the connecting assembly may be configured to connect to at least two of the inter-connecting wing sections. At least a portion of the inter-connecting wing sections may include a solar array having solar panels.

### CROSS-REFERENCE

The present application claims priority to U.S. Provisional Patent Application No. 61/846,508, filed Jul. 15, 2013, entitled “UAV WITH INTER-CONNECTING WING SECTIONS,” the entire disclosure of which is incorporated herein by reference tor all purposes.

### SUMMARY OF THE INVENTION

The present disclosure generally relates to an Unmanned Aerial Vehicle (UAV). The UAV may include a fuselage section or assembly and a plurality of inter-connecting wing sections. The wing sections may comprise, at opposing ends, one or more connecting assemblies that permit a first pair of wing sections to be connected to the fuselage assembly. The wing sections may further comprise, at the opposing end, a connector assembly that permit a second pair of wing sections to be connected, and so forth. The connector assembly at opposing lateral, ends may be complementary, e.g., male connectors at one lateral end and female connectors at the opposing lateral end. As can be appreciated, the female connectors may be sized, shaped, or otherwise configured to receive the male connectors. As such the UAV may be configured with one, two, three, four, or some other predetermined number of interconnecting wing sections, in pairs. One or more of the wing sections may include a solar panel to collect light and convert the light into an operating power source for the UAV.

Each of the inter-connecting wing sections may include a plurality of connectors at the opposing lateral ends. For example, a first lateral end may include one or more male connectors and the second lateral end (opposite the first end) may include a corresponding number and location of female connectors. The wing sections may include connectors configured to provide electronic communication between the wing sections, load bearing connectors, securing connectors, and the like. The fuselage assembly may include corresponding connectors configured to connect to the wing sections.

The UAV may also comprise a pay load assembly. The payload assembly may be configured to receive one or more pay loads to be transported by the UAV. The payload may be autonomous, such that it operates separate and independent from the UAV, or it may be an integral component of the UAV such that information, control, etc., signals are communicated between the payload assembly and the UAV. The payload assembly may also be semi-autonomous, e.g., may receive power, location information, etc., from the UAV, but may otherwise operate independently.

### BRIEF DESCRIPTION OF THE DRAWINGS

A further understanding of the nature and advantages of the present invention, can be realized by reference to the following drawings. In the appended figures, similar components or features may have the same reference label. Further, various components of the same type can be distinguished by hallowing the reference label by a dash and a second label that distinguishes among the similar components. If only the first reference label is used in the specification, the description is applicable to any one of the similar components having the same first reference label irrespective of the second reference label.

FIG. 1 is a perspective view of a UAV according to one aspect of the principles described herein;

FIG. 2 is a perspective view of a UAV according to one aspect of the principles described herein;

FIG. 3 is a perspective view of a UAV according to one aspect of the principles described herein;

FIG. 4 is a perspective view of a portion of a UAV according to one aspect of the principles; described herein;

FIG. 5 is a top plan view of an example of an inter-connecting wing section according to one aspect of the principles described herein;

FIG. 6 is a perspective view of an example of inter-connecting wing sections according to one aspect of the principles described herein; and

FIG. 7 is a top plan view of an example of an inter-connecting wing section according to one aspect of the principles described herein.

### DETAILED DESCRIPTION

Before explaining the presently disclosed and claimed inventive concept(s) m detail by way of exemplary embodiments, drawings, and appended claims, it is to be understood that the present disclosure is not limited in its application to the details of construction and the arrangement of the components set forth in the following description or illustrated in the drawings. The present disclosure is capable of other embodiments or of being practiced or carried out in various ways. As such, the language used herein is intended to be given the broadest possible scope and meaning; and the embodiments are meant to be exemplary—not exhaustive. It is to be understood that the phraseology and terminology employed herein is for the purpose of description and should not be regarded as limiting. Unless otherwise required by context, singular terms may include pluralities and plural terms may include the singular.

Generally, the present disclosed inventive concept(s) relate to an UAV comprising a plurality of inter-connecting wing sections. A portion (or each) of the plurality of inter-connecting wing sections may comprise a solar array consisting of one or more solar panels. The wing sections may comprise male and female connections on opposing ends configured such that the wing sections can be connected together and/or connected to a fuselage assembly. In one embodiment, the fuselage assembly includes male connections on one lateral, side and female connectors, complementary to the male connectors, on the opposing lateral aide, wherein each wing section includes a similar configuration of female connectors on one end and a similar configuration of male connectors on the opposing end. Accordingly, the inter-connecting wing sections can be received on, and securely connected to the complementary connectors of the fuselage assembly. Once connected, the UAV would now comprise the fuselage assembly and two wing sections. Further, the opposing ends of the connected wing sections may include the appropriate connector assembly such that additional wing sections can be connected to the opposing ends of the connected wing sections. Once these additional wing sections are connected, the UAV would comprise the fuselage assembly and four wings sections. Such addition of wing sections can then continue, if needed, for a desired conjuration. Accordingly, it can be appreciated that the presently disclosed UAV may utilize any manner of the inter-connecting wing sections, in pairs, on an as-needed basis. The wingspan of the UAV would be determined by the number of inter-connecting wing sections connected to the fuselage assembly. The connection of wing sections would be in pairs such that the number of wing sections on one side of the fuselage assembly is equal to the number of wing sections on the opposite side.

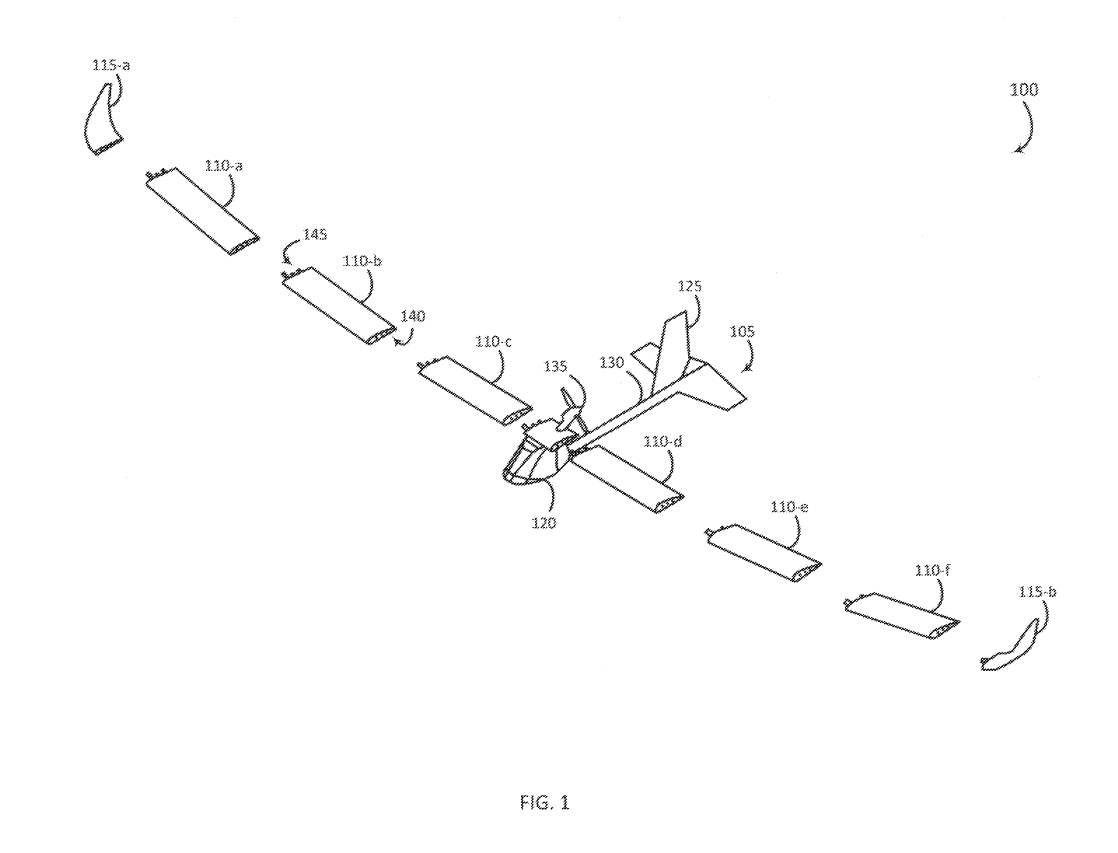

FIG. 1 shows a perspective view of a UAV 100 illustrating aspects of the present disclosure. The UAV 100 may include a fuselage assembly 105, a plurality of inter-connecting wing sections 110, and wing tips 115. Generally, the UAV 100 in FIG. 1 illustrates aspects of the inter-connecting wing sections and fuselage assembly in an expanded view to highlight an example of the connector assemblies used to connect the components together.

The fuselage assembly 105 may include a forward body 120, tail section 125, and a body 130. The forward body 120 may comprise a propulsion assembly 135 (shown as a propeller by way of example). One or more of the components of the fuselage assembly 105 may be integral and/or may be distinct components that can be connected together during operations. The wing tips 115 are optional and may be configured to provide for flight stability, etc. The wing tips 115 may include the connector assembly configured to connect to the wing sections 110, e.g., complementary connector assemblies.

Each of the wing sections 110 may include connecting assemblies on each opposing end that are complementary with respect to each other. As one example, the wing section 110-b (as wed as the other wing sections 110 and the fuselage assembly 105) may include a first connector assembly 140 on a first lateral end and a second connector assembly 145 on a second lateral end. The first lateral end is on an opposing side with respect to the second lateral end. Each of the wing sections 110 and the fuselage assembly 105 may have the same complementary connector assemblies on opposing ends such that the UAV 110 may be connected in a variety of configurations. For example, although FIG. 1 shows wing section 110-a being connectable to wing section 110-b and wing section 110-b being connectable to wing section 110-c, the complementary connector assemblies provide for any of the wing sections 110 to be connected to any of the other wing sections 110 and/or rite fuselage assembly 105.

The first connector assembly 140 may include one, two, three, or some other number of connection mechanisms. The second connector assembly 145 may include the same number of connection mechanisms, but in an opposing configuration, e.g., male-female connectors. Therefore, the first connector assembly 140 of wing section 110-b may be connectable to the complementary connector assembly 145 of wing section 110-c (not labeled).

Although FIG. 1 shows the UAV 100 with three pairs (six total) of inter-connecting wing sections 110, aspects of the present description may provide for a different number of wing sections 110 to be connected to the fuselage assembly 105, on a mission-dependent basis. For example, the UAV 100 may include two pairs (four total) wing sections 110 for a reduced weight/signature profile. As another example, the UAV 100 may include tour or more pairs of wing sections 110 for a wider wingspan and to collect additional solar energy (when equipped with a solar array). The complementary connector assemblies on opposing ends of the wing sections 110 and the fuselage assembly 105 provide for dynamically configuring the profile of the UAV 100 with any number of wing section 110 pairs.

The UAV 100 may also comprise electronic circuitry to perform various functionality including, but not limited to, monitoring, control, communications, operations, and the like. The electronic circuitry may be included in one or more of the wings sections 110, the fuselage assembly 105 (e.g., in the forward body 120), and/or combinations thereof. The electronic circuitry may be implemented as one or more modules, circuits, processors, and the like, processing analog and/or digital information designed to perform such functionality. The electronic circuitry may be configured to regulate and maximize solar power output for each wing section as well as function in coordination with other wing sections to maximize solar power output. The electronic circuitry may contain various sensors that are specific to an intended function or operational mission.

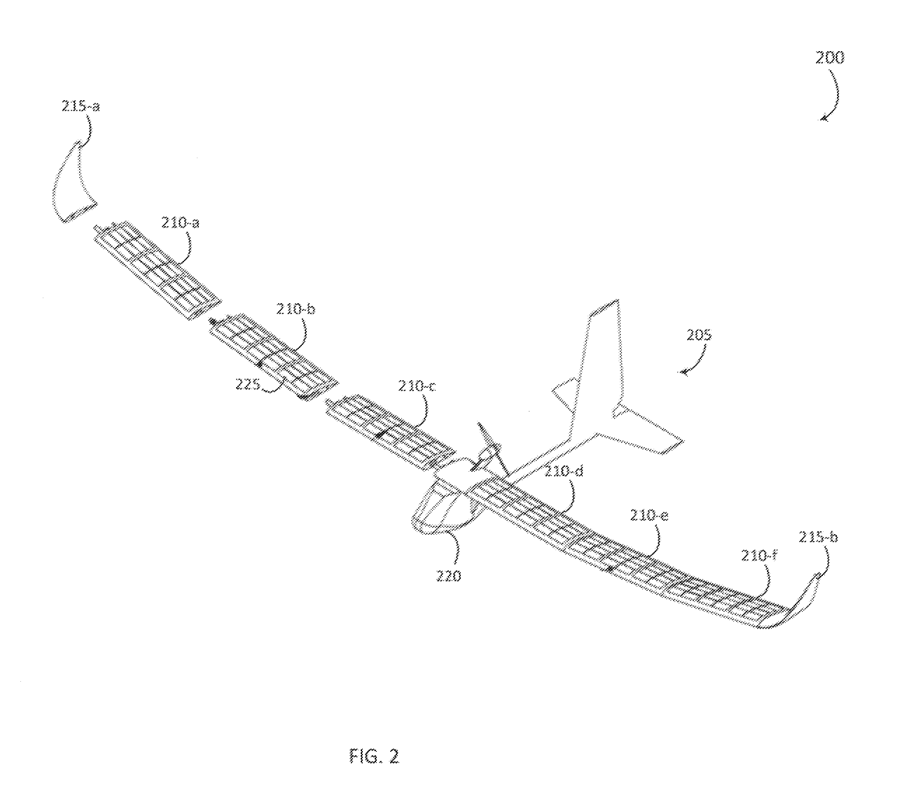

FIG. 2 shows a perspective view of a UAV 200 illustrating aspects of the present disclosure. The UAV 200 may be an example of one or more aspects of the UAV 100 described with reference to FIG. 1. Generally, FIG. 2 shows the UAV 200 in a partially expanded view wherein the inter-connecting wing sections on the port side are connected to the fuselage assembly. Additionally, FIG. 2 shows a configuration where each inter-connecting wing section includes solar arrays that include a plurality of solar panels.

The UAV 200 may include a fuselage assembly 205, a plurality of inter-connecting wing sections 210, and wing tips 215. As shown in FIG. 2, the wing sections 210 may also include a solar array that includes one or more solar panels 225.

The fuselage assembly 205 may include a forward body 220. The forward body 220 may include, on or near a top portion, the complementary set of the connecting assembly on opposing lateral ends. For example, the connector assembly on the port side may include one or more female connectors that are sized and shaped to receive the corresponding number and configuration of male connectors on the wing section 210-d. Similarly, the connector assembly on the starboard side may include one or more male connectors that are sized and shaped to be received in the corresponding number and configuration of female connectors on the wing section 210-c. As discussed above, each of the wing sections 210 are configured to be interchangeable with respect to each other such that each wing section 210 may be connectable to an adjacent wing section 210 and/or the fuselage assembly 205.

The connector assemblies for the wing sections 210 and/or fuselage assembly 205 may include, but are not limited to, a load bearing connection(s), a control connection(s), an electrical connection(s), a securing connection(s), and the like. The load bearing connections may be configured to maintain a structural integrity of the UAV 200 when the components are connected together (e.g., the wing sections 210 connected together and/or to the fuselage assembly 205). In one example, the male end of the load bearing connections may include a metallic rod protruding beyond the wing section 210 and/or the fuselage 205. The corresponding female end may include a tube section positioned within the wing section 210 and/or the fuselage 205 that is configured to receive the metallic rod when connected. It is to be understood that each of the wing sections 210 and/or the fuselage assembly 205 may include one, two, three, or any number of load bearing connections. Control connections may be electrical or mechanical and be configured such that various flight mechanisms of the UAV 210 may be controlled.

Electrical connections between the wing sections 210 and/or the fuselage assembly 205 may be wired, wireless, or combinations thereof. According to certain embodiments, the wing sections 210 and/or the fuselage assembly 205 may include an electrical connection that comprises one or more connectors. The one or more connectors may communicate data, control commands, status, power, etc., between the components of the UAV 200. The electrical connector may be configured such that when the wing sections 210 are connected together and/or to the fuselage assembly 205, the male and female electrical connectors on each end are securely connected together and in electrical communication. According to other aspects, the UAV 200 may also comprise an internal wireless system. For example, the internal wireless system may relay information, commands, and/or data between the structural components of the UAV 200. An exemplary internal wireless system may include a Bluetooth® system, near field communications (NFC), and the like.

Securing connections may permit the wing sections 210 and/or the fuselage assembly 205 to be, once mated together, securely connected such that the components will not separate during normal operations. In some aspects, the securing connections may be configured such that an operator can quickly assemble and disassemble the UAV 200. Exemplary securing connections include, but are not limited to, compression fittings, screws, pins, latches, and the like.

The UAV 200 may also include an energy harvesting and storage system. The energy harvesting and storage system may be in electrical communications with the wings sections 210 to collect the solar power being generated from the solar arrays via the solar panels 225. The system may regulate, distribute, store, etc., the solar power collected by the wing sections 210 to provide an operational power source for the UAV 200. In some aspects, each of the wing sections 205 may include an internal energy harvesting and/or storage system. For example, each wing section 210 may include dedicated power management electronic circuitry to facilitate optimal maximum power point tracking when solar panels 225 are applied to the wing sections 210. This may provide for each wing section to produce the maximum amount of power from the solar panels 225 and may, in some aspects, alleviate problems with solar panel 225 mismatch due to different illumination levels on individual panels due to orientation or other factors.

Alternatively or additionally, the system may comprise one or more battery storage systems that may be configured to provide the operational power to the UAV, e.g., in the situation where there is a temporary loss of sunlight. The battery storage systems may be charged by the energy harvesting and storage system during times when the solar power input is greater than the operational power required by the UAV.

As can be appreciated, the UAV 200 may also comprise such exemplary systems as a GPS-based guidance and location system, an inertial navigation system, an external wireless communication and control system, a data logging system, one or more processors controlling various functions, and the like. Such exemplary systems may be housed in the forward body 220, for example, and provide various functionality associated with UAV 200 operations.

The UAV 200 may also comprise a payload system. For example, the forward body 220 may include the payload system that is configured to receive a payload and provide, in some aspects, interface wish one or more systems of the UAV 200. The payload system may be configured to receive a wide variety of pay loads. The payloads may be autonomous such that no electrical interface with the UAV 200 is required. In such an autonomous payload, the payload system may be configured to provide a secure mechanical connection for the payload to be carried in the UAV 200. In operation though, the autonomous payload may not otherwise communicate with one or more systems of the UAV 200. Other payloads may be more integrated into aspects of the UAV 200. For instance, such payloads may be configured to draw power from the UAV 200, receive location information from the UAV 200, be remotely controlled via the external wireless communications and control system of the UAV 200, and the like. Accordingly, the payload system may include electrical and/or mechanical connections for the payload to connect to so as to be integrated, at least to some degree, into the UAV 200.

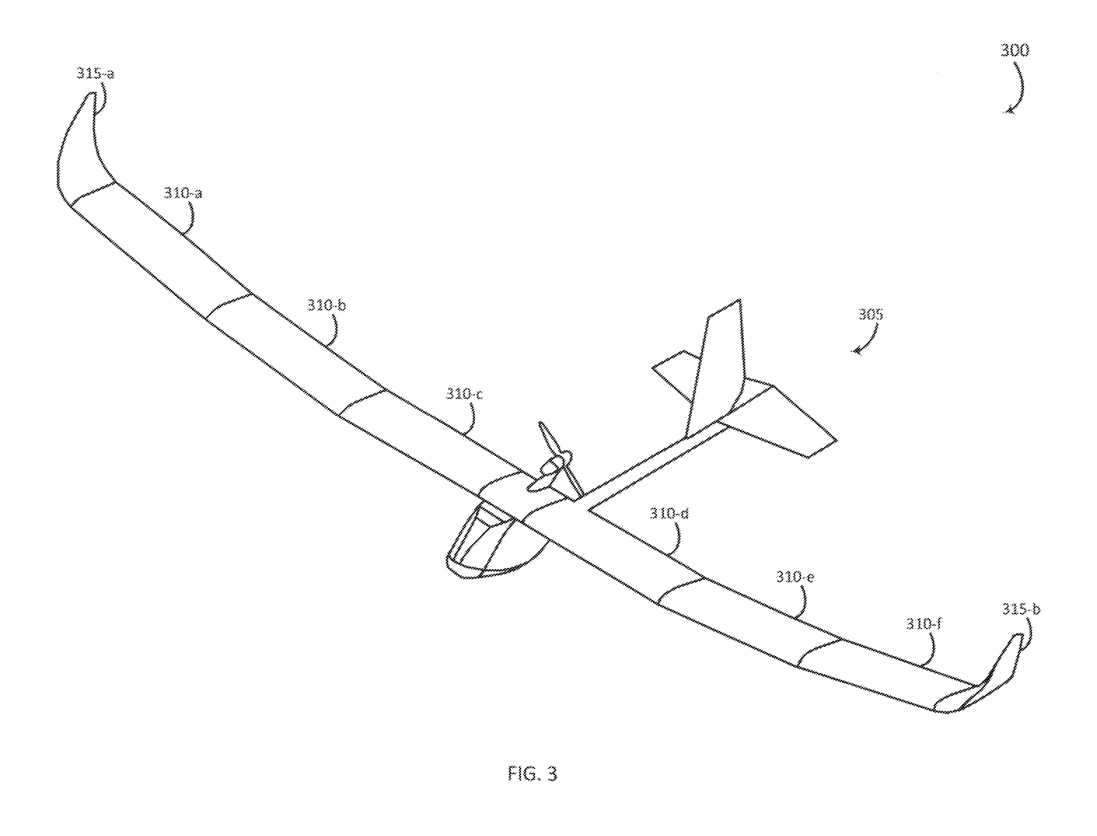

FIG. 3 is a perspective view of an example of a UAV 300 according to one aspects of the principles described herein. The UAV 300 may be an example of and include aspects of the UAVs 100 or 200 described with reference to FIGS. 1 and/or 2. Generally, FIG. 3 shows the UAV 300 in an operational state where all of the inter-connecting wing sections are connected.

The UAV 300 may include a fuselage assembly 305, a plurality of inter-connecting wing sections 310, and wing tips 315. The inter-connecting wing sections 310 are connected together and to the fuselage assembly 305 to provide tor the structure of the UAV 300, e.g., to provide lift, rigidity, operational capability, etc. Again, although FIG. 3 shows the UAV 300 with three pairs (six total) of inter-connecting wing sections 310, it is to be understood that aspects of the present description may provide for the UAV 300 to have fewer or more wing sections 310. In one example where the UAV 300 is equipped with solar arrays, additional pair's of wing sections may provide for increased solar energy capacity to extend High duration. As another example, fewer wing sections 310 may reduce weight and provide for shorter fight durations with greater speed.

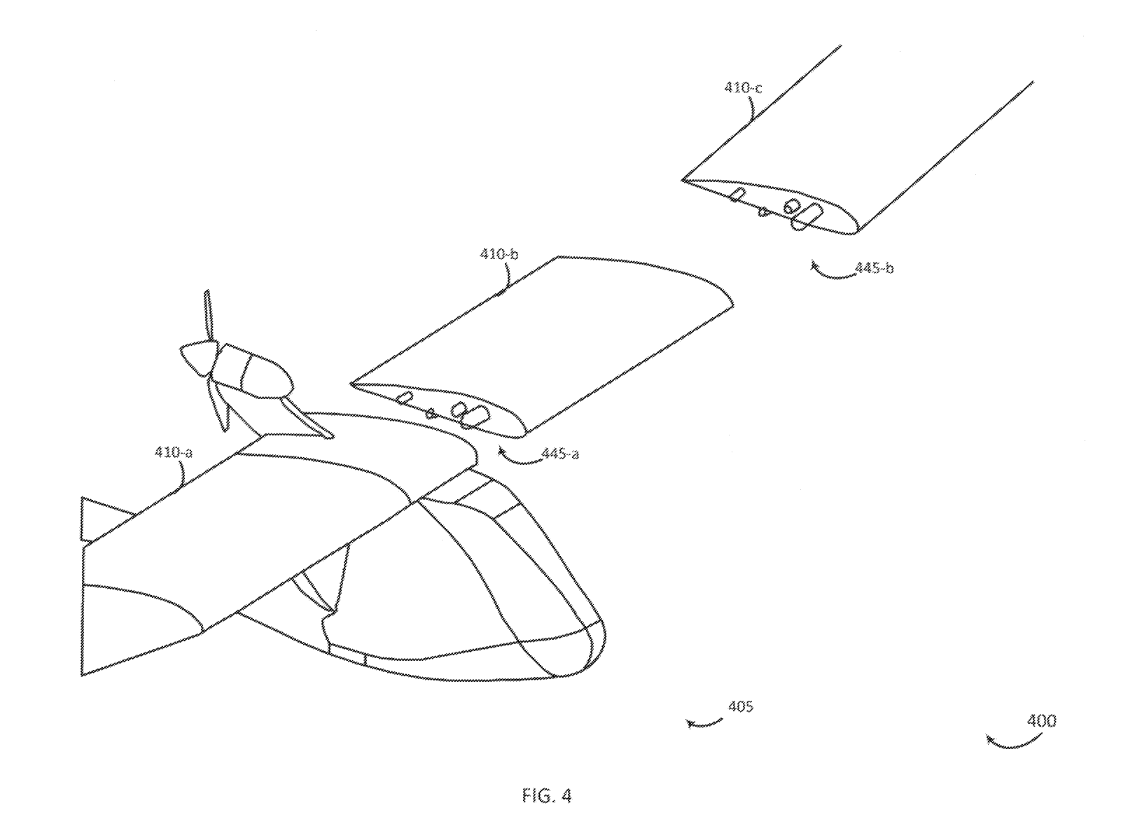

FIG. 4 is a perspective view of an example of a UAV 400 according to one aspects of the principles described herein. The UAV 400 may be an example of, and include aspects of the UAVs 100, 200 and/or 300 described with reference to FIGS. 1, 2, and/or 3. Generally, FIG. 4 shows a partial view of the UAV 400 with the wings sections on the port side in an expanded view.

The UAV 400 may include a forward body 405 and a plurality of inter-connecting wing sections 410. On the starboard side, the wing section 410-a is connected to the fuselage assembly 405 via the complementary connector assemblies on each component.

On the peat side, the wing section 410-b is positioned to be connected to the lateral end of the top portion of the fuselage assembly 405. Although not shown in FIG. 4, the top portion of the fuselage assembly 405 may include a complementary connector assembly with respect to the connector assembly 445-a of wing section 410-b. In the example connector assembly 445-a, the wing section 410-b may include three male connector mechanisms and one latch mechanism. Therefore, the top portion of the fuselage assembly 405 may include three remote connector mechanisms and one latch receiving mechanism. Accordingly tie connector assemblies of the fuselage assembly 405 and the wing section 410-b are complementary with respect to each other and, therefore, the wing section 410-b may be connected to the fuselage assembly 405.

Similarly, the wing section 410-c is positioned to be connected to the lateral end of fire wing section 410-b. Although not shown in FIG. 4, the lateral end of the wing section 410-b adjacent to the wing section 410-c may include a complementary connector assembly with respect to the connector assembly 445-b of wing section 410-c. Accordingly the connector assemblies of the wing sections 410-b and 410-c are complementary with respect to each other and, therefore, the wing section 410-c may be connected to the wing section 410-b.

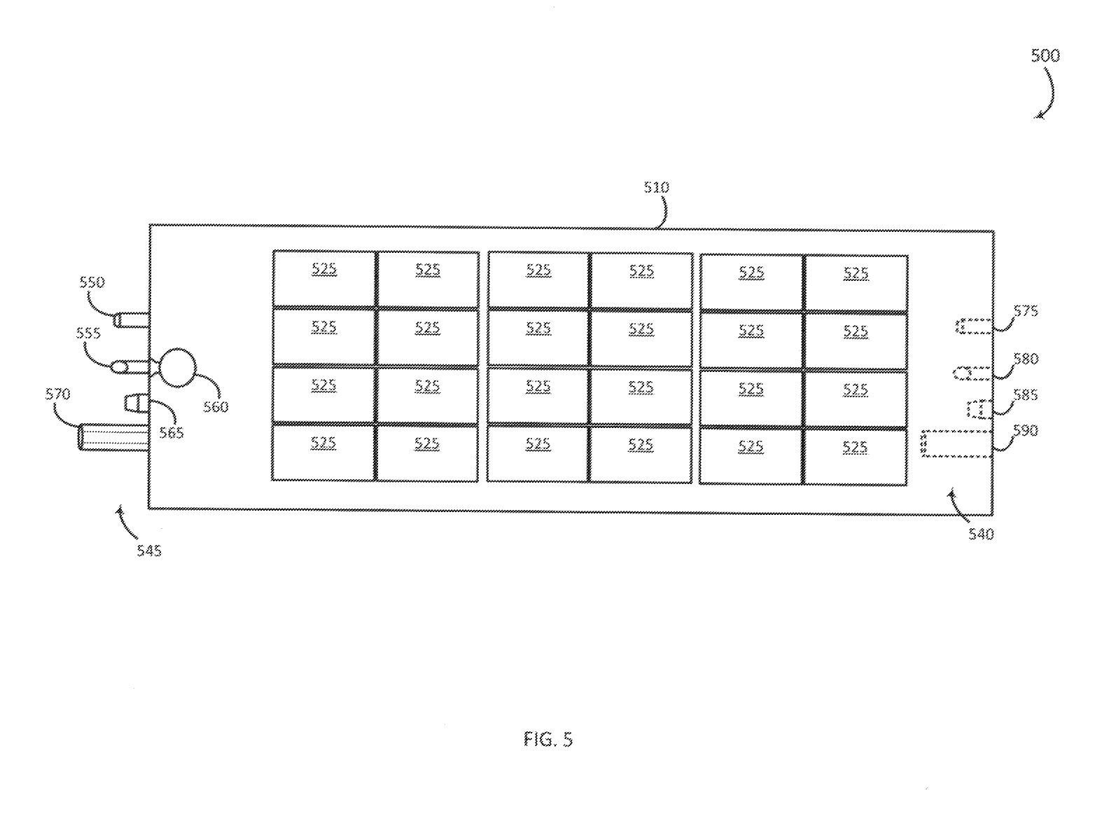

FIG. 5 shows a top plan view of an example of an inter-connecting wing section 510 according to one aspect of the principles described herein. The wing section 510 may be an example of, and incorporate aspects of one or more of the wing sections 110, 210, 310, and/or 410 described with respect to FIGS. 1, 2, 3, and/or 4. Generally, the wing section 510 shows one example of a complementary connector assembly.

The wing section 510 may include a solar array consisting of a plurality of solar panels 525. Although the wing section 510 is shown as having 24 solar panels 225, it is to be understood that fewer or more solar panels 225 may be incorporated into the wing section 225.

The wing section 510 may include a connector assembly 545 on a first lateral end and a connector assembly 540 on a second lateral end. The connector assemblies are complementary with respect to each other, as is described below.

The wing section 510 may include a male secondary load pin 550 on the first lateral end and a complementary female secondary load pin 575 on the second lateral end. The male secondary load pin 550 may be configured to be received in a female secondary load pin on an adjacent wing section and/or fuselage assembly. Similarly, the female secondary load pin 575 may be configured to receive a male secondary load pin of an adjacent wing section and/or fuselage assembly. Accordingly, the male and female secondary load pins 550 and 575, respectively, are complementary with respect to each other. The secondary load pin mechanisms may provide for additional structural support for the inter-connecting wing section 510 during operation.

The wing section 510 may also include a male latching mechanism (consisting of connector latch 555 and release paddle 560) on the first lateral end and a complementary latch receiving mechanism 580 on the second lateral end. The latching mechanism may be configured such that the connector latch 555 rotates about a pin when an operator pushes on the release paddle 560. Accordingly, the connector latch 555 may rotate to an open or disconnect position when the release paddle 500 is pushed down and rotate to a closed or connect position when the release paddle 560 is not pushed down. The connector latch 555 and/or the release paddle 560 may be spring loaded such that the release paddle is normally in the closed or connect position, e.g., when not being pushed. The latching mechanism may be configured to be received in and/or otherwise connected to a latch receiving mechanism on an adjacent wing section and/or fuselage assembly. Similarly, the latch receiving mechanism 580 may be configured to receive and/or otherwise connect to latching mechanism on an adjacent wing section and/or fuselage assembly. Accordingly, the latching mechanism and the latch receiving mechanism 580 are complementary with respect to each other. The latching mechanisms may provide for a secure connection between inter-connecting wing sections and/or a fuselage assembly during operation.

The wing section 510 may also include a male electrical connector 565 on the first lateral end and a complementary female electrical connector 585 on the second lateral end. The male electrical connector 565 may be configured to be received in a female electrical connector on an adjacent wing section and/or fuselage assembly. Similarly, the female electrical connector 585 may be configured to receive a male electrical connector of an adjacent wing section and/or fuselage assembly. Accordingly, the male and female electrical connectors 565 and 585, respectively, are complementary with respect to each other. The electrical connectors may provide for electrical communications between components of a UAV during operation, e.g., power, control signaling, data, etc.

The wing section 510 may also include a male primary load pin 570 on the first lateral end and a complementary female primary load pin 590 on the second lateral end. The male primary load pin 570 may be configured to be received in a female primary load pin on an adjacent wing section and/or fuselage assembly. Similarly, the female primary load pin 590 may be configured to receive a male secondary load pin of an adjacent wing section and/or fuselage assembly. Accordingly, the male and female primary load pins 570 and 590, respectively, are complementary with respect to each other. The primary load pin mechanisms may provide for structural support for and between the inter-connecting wing sections during operation.

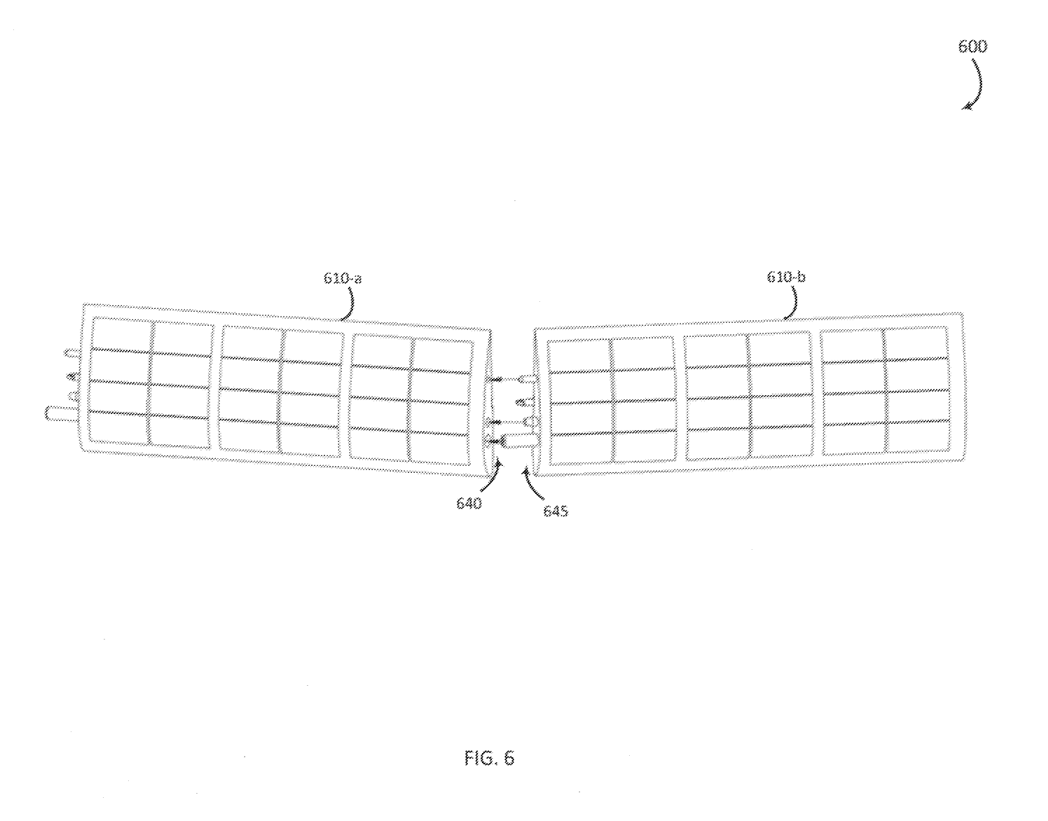

FIG. 6 shows a perspective view of an example of inter-connecting wing sections 610-a and 610-b according to one aspect of the principles described herein. The wing sections 610 may be examples of, and incorporate aspects of one or more of the wing sections 110, 210, 310, 410, and/or 510 described with respect to FIGS. 1, 2, 3, 4, and/or 5. Generally, FIG. 6 shows the wing sections 610 in an expanded view and positioned to be connected together. FIG. 6 illustrates how the male connectors on a wing section would be received inside the female connectors of the adjacent wing section.

The wing section 610-a may include a connector assembly 640 and the wing section 610-b may include a connector assembly 645. The connector assemblies 640 and 645 are complementary with respect to each other. For example, the connector assembly 645 may be configured to be received into and/or otherwise connected to the connector assembly 640 such that the wing sections 610 are connected together.

Although not labeled, it can be appreciated that the wing section 610-a also includes a connector assembly on the opposing lateral end that is the same as the connector assembly 645 of wing section 610-b. Accordingly, the wing section 610-a may also be connected to an adjacent wing section and/or the fuselage assembly.

Similarly, it can also be appreciated with the wing section 610-b may include a connector assembly (not shown) on the opposing lateral end that is the same as the connector assembly 640 of wing section 610-a. Accordingly, the wing section 610-b may be connected to an adjacent wing section and/or fuselage assembly.

Although the descriptions above generally describe the connector assemblies as having male connectors on one lateral end and female connectors on the opposing lateral end, it is to be understood that the present disclosure is not limited to this configuration. For example, the connector assemblies may include any number and/or mix of male and female connectors, as well as other connecting mechanisms. In some aspects, one or more of the inter-connecting wing sections and/or the fuselage assembly may include a complimentary set of connector assemblies that are designed to break apart when a force having a known strength and/or direction are applied, e.g., during landing.

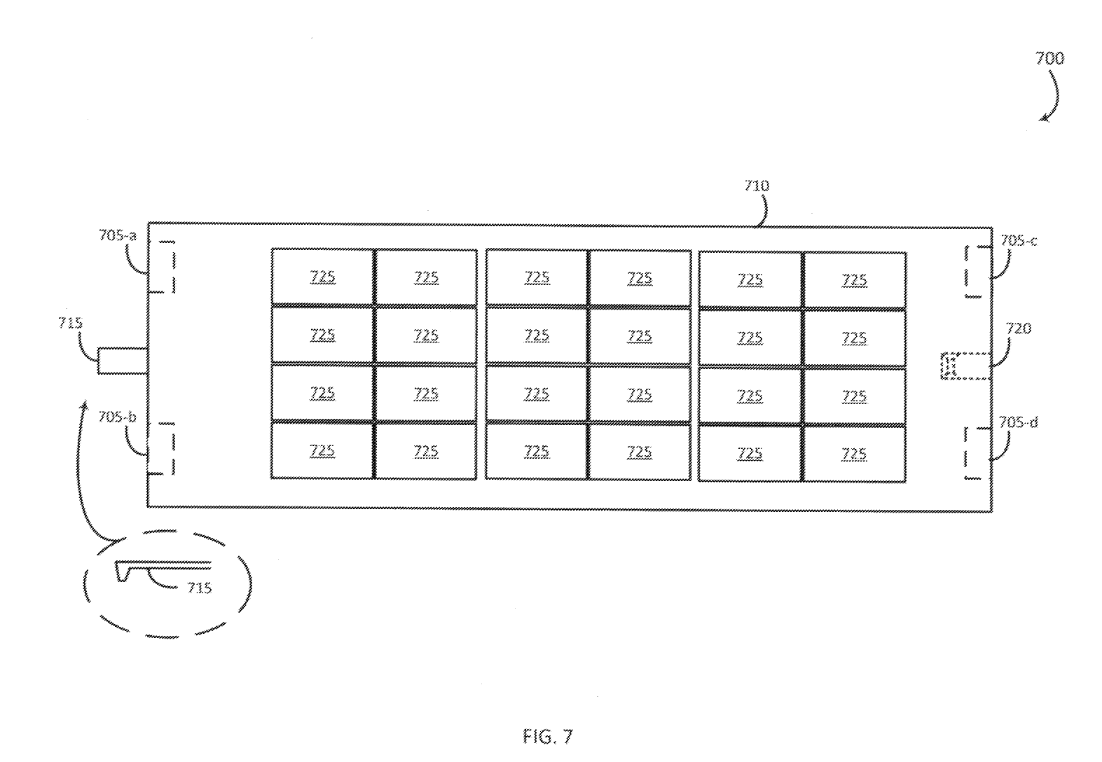

FIG. 7 is atop plan view of an example of an inter-connecting wing section 710 according to one aspect of the principles described herein. The wing section 710 may be an example or and/or incorporate one or more aspects of the wing sections 110, 210, 310, 410, 510, and/or 610 described above with respect to FIGS. 1, 2, 2,4, 5, and/or 6. Generally, the wing section 710 is configured such that at least a portion of the complementary connecting assembly is configured to automatically break apart when a predetermined stress is applied.

The wing section 710 may include a solar array consisting of solar panels 725. The wing section 710 may also include a plurality of magnets 705 and a one-way latching mechanism (including latching pin 715 and latching pin receiver 720). The magnets 705 may be rare earth magnets, for example, and may be sized or otherwise configured to keep the adjacent sections of the wing sections and/or the fuselage assembly connected during normal operations, e.g., take-off, flight and landing.

The one-way latching mechanism, alone and/or in combination with the magnets 705, may be configured such that the portion of the complementary connecting assembly configured to break apart is configured to break apart when the predetermined stress is applied in a first vertical direction (e.g., downward) and configured to not break apart if the predetermined stress is applied in a direction other than the first vertical direction. The wing section 710 may generally orientated (e.g., downward) such that the latching pin 715 may be inserted into and received within a latching pin receiver of an adjacent wing section and/or fuselage assembly. Once inserted, the adjacent wing sections (or wing section and fuselage assembly) may be brought into a substantially parallel orientation such that the magnets 705 connect to secure the wing sections/fuselage assembly together. During landing, for example, the downward force associated with a hard landing may be sufficient to break the connections of the magnets 705 and permit the adjacent wing sections/fuselage assembly to release the hook portion of the latching pin 715 from the latching pin receiver 720. Accordingly, the wing sections and/or fuselage assembly may break apart during a particularly difficult landing to prevent structural damage, tor example, to the UAV.

Turning now to additional aspects of the present disclosure, one, some or all of the wing sections may include one or more solar arrays (e.g., three solar arrays consisting of three solar panels each). The solar arrays may collect ambient light and convert it to an operational power for the UAV. In low light conditions, for example, additional wing sections may be connected to the UAV to capture as much light as possible. Such additional wing sections may also provide additional lift. In some aspects, the solar panels may be high efficiency flexible solar cells manufactured by Microlink Devices, Inc., based in Niles, Ill. The high efficiency, lightweight, and flexible solar panels may be based on the epitaxial lift-off (ELO) process. In one embodiment, the solar panels on the wing sections may provide 100% of the operation power required by the UAV.

The wing sections and/or fuselage assembly may be configured to have an aerodynamic profile so as to provide lift for the UAV. As can be appreciated, different wing sections of the UAV may have different aerodynamic profiles such that some sections favor high speed operations (i.e., less lift) and others may favor low speed operations (i.e., more lift). As such, the UAV may provide flexibility during assembly such that the operator can select the wing sections to connect together based on the mission.

The payload system may be positioned on the nose or forward body of the UAV. As previously discussed, the payload system may be configured to receive an autonomous payload or an integrated payload. Exemplary payloads include, but are not limited to, an image capturing device, a photogrammetric device, an audible capturing device, an environmental monitoring and measurement device, a dispersible device, and the like.

Further, although the payload system is described as being on the nose or forward body of the UAV, other configurations arc also considered within the scope of the disclosure. For example, the payload system may be positioned on the bottom of the fuselage assembly to provide a nadir view with respect to the UAV. In another example, the payload system may be integrated into the wing tip sections (e.g., an image capturing device positioned in each wing tip section to capture a 3-D Image).

In some aspects, the payload system may be configured to orient the payload in a static orientation or may be configured to vary the orientation of the payload during operation. That is, the payload system may include one or more servos and the like as well as a gyroscope such that the orientation of the payload may be known at all times and changed as needed. Such dynamic control of the payload may be predetermined (e.g., pre-programmed before flight to occur at certain times of the flight) or may be controlled during operation (e.g., an operator may control the payload during flight via an external wireless system).

The components of the UAV may be disconnected and arranged in a packed configuration. As can be appreciated, the inter-connecting wing sections connectable together and to the fuselage assembly permit the UAV to be disassembled and easily transported. Furthermore, toe fuselage assembly can also be configured such that it can be disassembled for transport and reassembled for operation.

The described UAV may be a long-endurance solar UAV that utlizes high efficiency flexible solar panels (+30%) arid a modular design. The wingspan (assembled) and operational weight can be varied by the number of interconnecting wing sections used. The UAV may be disassembled and stored in a very small volume and easily transported by a single operator. The UAV may use six (or some other quantity) identical solar wing sections that can easily be replaced/swapped (each wing section “plugs” into the adjacent wing section). Additionally, the wing sections may be removed to increase dash speed with shorter wingspan. Individual wing sections may be used on the ground as solar panels to charge other devices, for example. The forward facing payload system may be modular and can include gimbaled cameras or other sensors/payloads.

Individual wing sections may be replaced if damaged, which reduces operations costs when compared to replacing an entire wing. Extra wing sections may be included in the total kit to ensure mission availability and readiness (e.g., a kit might include two extra wing sections along with the standard quantity of wing sections.

The described long-endurance solar UAV may have a predetermined dash speed (dependent on the number of wing sections used) and also a predetermined loiter speed (again depending on the number of wing sections used). When loitering, the UAV can fly as long as there is substantial sunlight. Further, the UAV may be configured for a predetermined maximum loiter altitude.

Each interconnecting wing section may comprise dihedral for increased stability in flight. When assembled, the UAV may have a high aspect ratio wing for more efficiency during flight. Physical and electrical connections are built into each wing section.

The embodiments discussed herein are illustrative of the presently disclosed inventive concepts. As these embodiments are described with reference to illustrations, various modifications or adaptations of the methods and/or specific structures described may become apparent to those skilled in the art. All such modifications, adaptations, or variations that rely upon the teachings of the present disclosure, and through which these teachings have advanced the art, are considered to be within the spirit and scope of the present disclosure. Hence, these descriptions and drawings should not be considered in a limiting sense, as it is understood that the present disclosure is in no way limited to only the embodiments illustrated.

What is claimed is:

1. An unmanned aerial vehicle (UAV) comprising:
a plurality of inter-connecting wing sections, each inter-connecting wing section comprising a connecting assembly on opposing lateral ends, wherein the connecting assembly is complementary on opposing ends and the opposing connecting assembly is configured to connect the wing sections together; and
a fuselage assembly comprising a complementary set of the connecting assembly on opposing lateral ends, wherein the complementary set of the connecting assembly is configured to connect to at least two of the interconnecting wing sections.

2. The UAV of claim 1, further comprising:
one or more solar arrays integrated into at least one of the plurality of inter-connecting wing sections.

3. The UAV of claim 1, wherein each of the plurality of inter-connecting wing sections comprises a solar array.

4. The UAV of claim 1, wherein the complementary connecting assembly comprises;
one or more female connectors positioned on a first lateral end; and
a corresponding number of male connectors positioned on a second lateral end, wherein the second lateral end is located on an opposing side of the first lateral end.

5. The UAV of claim 4, wherein the female connectors are sized and shaped to receive the male connectors.

6. The UAV of claim 1, wherein the complementary connecting assembly comprises:
at least one magnet positioned on each lateral end;
a latch assembly positioned on a first lateral end; and
a latch receiving assembly positioned on a second lateral end located on an opposing side of the first lateral end.

7. The UAV of claim 6, wherein the latch receiving assembly is sized and shaped to receive the latch assembly.

8. The UAV of claim 1, wherein the complementary connecting assembly comprises:
one or more female connectors and one or more male connectors positioned on a first lateral end; and
a corresponding number of female and male connectors positioned on a second lateral end, wherein, the second lateral end is located on an opposing side of the first lateral end.

9. The UAV of claim 8, wherein the female connectors are sized and shaped to receive the male connectors.

10. The UAV of claim 1, wherein each of the plurality of inter-connecting wing sections comprises one or more of an electrical connector, a load hearing connector, and a connecting mechanism.

11. The UAV of claim 1, wherein at least a portion of the complementary connecting assembly is configured to automatically break apart when a predetermined stress is applied.

12. The UAV of claim 11, wherein the portion of the complementary connecting assembly configured to break apart is configured to break apart when the predetermined stress is applied in a first vertical direction and configured to not break apart if the predetermined stress is applied in a direction other than the first vertical direction.

13. The UAV of claim 1, further comprising:
a payload assembly configured to receive a payload.

14. The UAV of claim 13, wherein the pay load assembly is configured to integrate an autonomous payload.

15. The UAV of claim 13, wherein the payload assembly is configured to integrate a non-autonomous payload, the non-autonomous payload configured to communicate one or more of a control signal, a communications signal, a data signal, and a feedback signal.

16. The UAV of claim 1, further comprising two wing tip assemblies configured to connect to at least two of the plurality of inter-connecting wing sections that are connected on far opposing ends of the UAV.

17. the UAV of claim 1, wherein the connecting assembly is configured to communicate one or more of a power signal, a control signal a data signal, and a feedback signal.

18. An inter-connecting wing section, comprising:
a plurality of connectors positioned on a first lateral end; and
a corresponding number of connectors positioned on a second lateral end, the second lateral end being on an opposing side with respect to the first lateral end.

19. The inter-connecting wing section of claim 18 wherein, each of the first and second lateral ends comprise both female and male connectors.

20. The interconnecting wing section of claim 18, bother comprising a solar array.
